(19) United States
(12) Patent Application Publication
(10) Pub. No.: US 2013/0307200 A1
(43) Pub. Date: Nov. 21, 2013

(54) Sintered Polycrystalline Silicon-based Thermoelectrics

(71) Applicants: John Carberry, Talbott, TN (US); Andrew A. Wereszczak, Oak Ridge, TN (US)

(72) Inventors: John Carberry, Talbott, TN (US); Andrew A. Wereszczak, Oak Ridge, TN (US)

(21) Appl. No.: 13/667,623

(22) Filed: Nov. 2, 2012

Related U.S. Application Data
(60) Provisional application No. 61/554,738, filed on Nov. 2, 2011.

(51) Int. Cl. C04B 35/64

(52) U.S. Cl. CPC C04B 35/64
USPC 264/614; 252/500; 252/512; 252/515

(57) ABSTRACT

Methods and processes to fabricate thermoelectric materials and more particularly to methods and processes to fabricate doped silicon-based semiconductive materials to use as thermoelectrics in the production of electricity from recovered waste heat. Silicon metal particulates, extracting liquid, and dopant are combined into a mixture and milled. Substantially oxidant-free and doped silicon metal particulates are recovered and sintered to form a porous polycrystalline silicon-based thermoelectric material.

### CROSS-REFERENCE TO RELATED APPLICATIONS

This Application claims the benefit under 35 U.S.C. section 119(e) of U.S Provisional Patent Application No. 61/554,738, filed Nov. 2, 2011.

### STATEMENT REGARDING FEDERALLY SPONSORED RESEARCH OR DEVELOPMENT

This invention was made with government support under DE-AC05-00OR22725 awarded by the U.S. Department of Energy. The government has certain rights in the invention.

### BACKGROUND OF THE INVENTION

1. Field of Invention

The present general inventive concept relates to the preparation and use of thermoelectric materials and more particularly to methods and processes to fabricate silicon-based semiconductive materials to use in the production of electricity from recovered waste heat.

2. Description of the Related Art

Semiconductive materials that exhibit the Seebeck effect in the presence of a temperature gradient are useful for the production of electricity from waste heat. The class of semiconductive materials exhibiting the Seebeck effect is hereinafter called thermoelectrics or thermoelectric materials.

A number of contemporary thermoelectrics comprise alternating p-type and n-type semiconductor elements connected by metallic connectors. Many contemporary thermoelectrics present various disadvantages, including, in some instances, high material costs, high costs of production, difficulty of manufacture, the use of rare elements, the use of potentially carcinogenic or toxic substances, and limited formability.

The Seebeck coefficient (S) of a material is a measurement of the magnitude of an induced thermoelectric voltage in response to a temperature difference across that material. Optimally, a highly efficient thermoelectric material should have a high Seebeck coefficient, high electrical conductivity, and low thermal conductivity and be able to operate at high temperatures, meaning it should have a low coefficient of thermal expansion. See, e.g., Ci et al., Materials Letters 65, 1618-1620 (2011). Other considerations arise as well. It is desirable that a thermoelectric material be susceptible to being worked to construct planar and complex net-shaped objects that can be fitted into locations where they may be used to recover waste heat. Such a thermoelectric material should have a cross section with properties to maintain a sufficiently high temperature differential between the two opposing sides in order to generate voltage efficiently. It is also desirable that a thermoelectric material have high tensile strength, have resistance to thermal shock, and be formable into layers to allow the creation of graded indices for electrical, thermal, or other parameters—allowing one thermoelectric material to serve as the basis for a range of thermoelectric devices.

### BRIEF SUMMARY OF THE INVENTION

Disclosed herein are methods and processes to fabricate thermoelectric materials and more particularly methods and processes to fabricate doped silicon-based semiconductive materials to use as thermoelectrics in the production of electricity from recovered waste heat.

In an example embodiment of the present invention, a method for fabricating a sintered polycrystalline silicon-based thermoelectric material begins by providing an initial feedstock of silicon metal particulates, an extracting liquid to extract oxidants from the silicon metal particulates, and a dopant to affect the semiconductive properties of the final silicon-based thermoelectric material. In many embodiments, the specific dopant mixed with the silicon metal particulates determines whether the final product is better suited to act as an n-type element or p-type element in a thermoelectric device. The silicon metal particulates, the extracting liquid, and the dopant are combined into a mixture and milled. After milling, at least a portion of the milled mixture is withdrawn and sent on to further processing, where the doped and milled silicon metal particulates are separated from the extracting liquid and unreacted dopant in the mixture. In several embodiments, the separation of the extracting liquid from milled silicon metal particulates takes place in the presence of an inert gas, minimizing the chance of the milled silicon metal particulates being oxidized or otherwise reacting with constituents in the air. The separated extracting liquid and unreacted dopant are withdrawn; the extracting liquid carries with it most or substantially all of the oxidants that contaminated the unmilled silicon metal particulates and would otherwise contaminate the final silicon-based thermoelectric material. The substantially oxidant-free and doped silicon metal particulates are recovered and sintered to form the desired polycrystalline silicon-based thermoelectric material. In many embodiments, the sintering process takes place under an inert atmosphere.

In another example embodiment of the present invention, a method for fabricating a sintered polycrystalline silicon-based thermoelectric material involves providing an initial feedstock of silicon metal particulates and providing an extracting liquid to extract oxidants from the silicon metal particulates. The silicon metal particulates and the extracting liquid are combined into a mixture and milled. After milling, at least a portion of the milled mixture is withdrawn and sent on to further processing, where the milled silicon metal particulates are separated from the extracting liquid. In several embodiments, the separation of the extracting liquid from milled silicon metal particulates takes place in the presence of an inert gas, minimizing the chance of the milled silicon metal particulates being oxidized or otherwise reacting with constituents in the air. The separated extracting liquid is withdrawn, carrying with it most or substantially all of the oxidants that contaminated the unmilled silicon metal particulates and would otherwise contaminate the final silicon-based thermoelectric material. In some embodiments, the extracting liquid separated from the mixture is then recycled to be mixed with unmilled initial feedstock silicon metal particulates. The substantially oxidant-free silicon metal particulates are recovered and mixed with a dopant to affect the semiconductive properties of the final thermoelectric material; in particular, in many embodiments, the specific dopant mixed with the silicon metal particulates determines whether the final product is better suited to act as an n-type element or p-type element in a thermoelectric device. The mixed silicon metal particulates and dopant are then milled together in a second mill, and doped silicon metal particulates are recovered and sintered to form the desired the polycrystalline silicon-based thermoelectric material. In many embodiments, the sintering process takes place under an inert atmosphere.

In several example embodiments, the final product is a silicon-based thermoelectric material comprising a heterogeneous mixture of silicon metal particulates, substantially free of oxidants, with a dopant added to affect the semiconductive properties of the thermoelectric material, the heterogeneous mixture having been sintered to form a polycrystalline silicon-based thermoelectric material. In some example embodiments, the thermoelectric material includes at least two layers having different thermoelectric properties.

In some of the several embodiments, the present invention allows for the fabrication of planar, net-shaped, or complexly shaped thermoelectric devices that are capable of being installed in a variety of places, and in particular are capable of being installed in places to absorb waste heat from machinery or equipment and transform the waste heat into electricity. For example, thermoelectric devices according to some of the example embodiments of the present invention are capable of being wrapped around pipes in some industrial settings, absorbing heat from the pipe.

### BRIEF DESCRIPTION OF THE SEVERAL VIEWS OF THE DRAWINGS

The above-mentioned features and other aspects of the invention will become more clearly understood from the following detailed description of the invention read together with the drawings in which:

FIG. 1 is a flow diagram of an example embodiment of a method for fabricating a thermoelectric material;

FIG. 2 is a flow diagram of an example embodiment of a method for fabricating a thermoelectric material; and

FIG. 3 is a sectional view of an example embodiment of a thermoelectric device in which several layers of thermoelectric material are combined.

### DETAILED DESCRIPTION OF THE INVENTION

Disclosed herein are methods and processes to fabricate thermoelectric materials and more particularly to methods and processes to fabricate doped silicon-based semiconductive materials to use as thermoelectrics in the production of electricity from recovered waste heat. In some example embodiments, the present invention comprises a thermoelectric material that incorporates a sintered polycrystalline silicon-based semiconductor material.

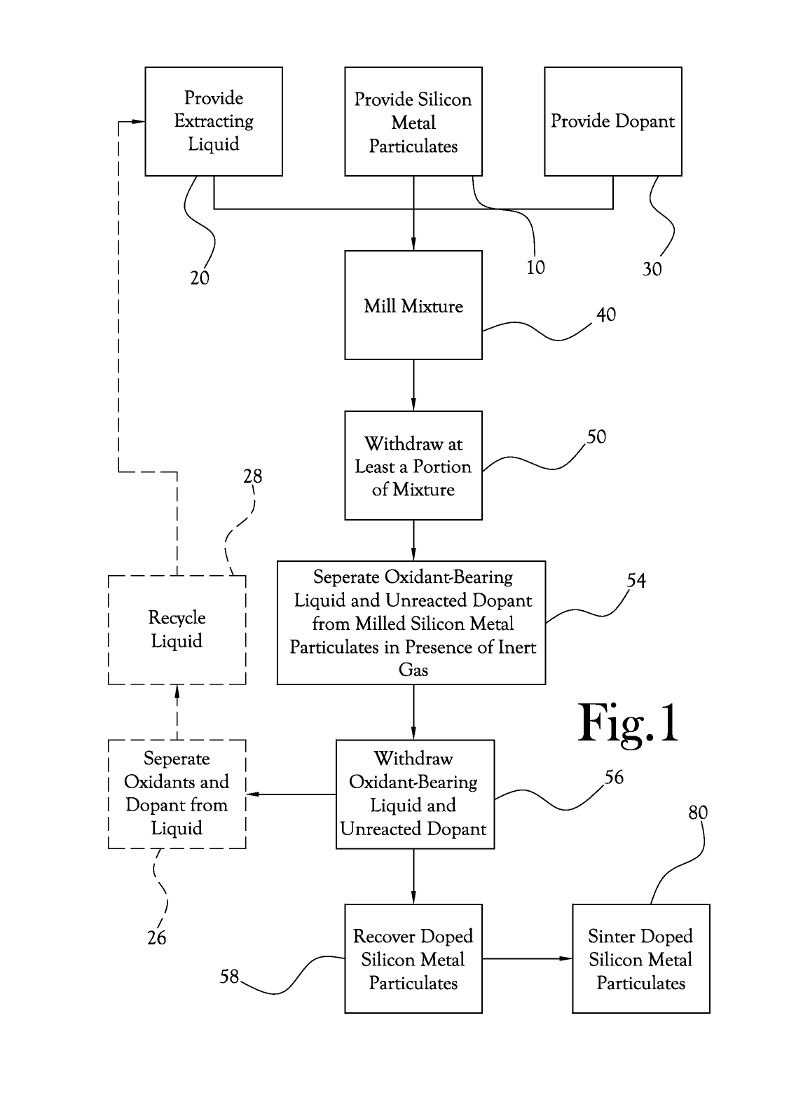

FIG. 1 is a flow diagram illustrating an example embodiment of the present invention. A method for fabricating a sintered polycrystalline silicon-based thermoelectric material begins by providing an initial feedstock of silicon metal particulates 10 and by providing an extracting liquid 20 to extract oxidants from the silicon metal particulates. In some embodiments, the silicon metal particulates initial feedstock has an average particle size of about 100 microns, such as lump silicon metal or metal particulates. If proper safety precautions are employed, it is possible to employ silicon metal particulates of substantially any initial average particle size, but several embodiments of the present invention contemplate that the first quantity of average particle size of the silicon metal particulates feedstock will be in that range of average particle sizes where the silicon metal is essentially non-violently reactive with ambient oxidants such as moisture, oxygen in air, or the like.

The extracting liquid is a liquid suitable to the extraction of oxidants—such as water, oxygen, hydroxyl radicals, and the like—from the silicon metal particulates. In an example embodiment of the present invention, the liquid oxidant extractant employed is ethanol or isopropyl alcohol. In some embodiments, other liquids or combinations of liquids which are essentially inert to silicon and which are capable of extracting oxidants from silicon particulates are employed. In some embodiments, the extracting liquid is readily distilled for purposes of separating oxidants from the liquid, whereafter the extracting liquid is recycled. Examples of such other liquids include many dry alcohols. In many embodiments, an alcoholic extracting liquid also protects freshly exposed slicon surfaces from oxidation during the milling process.

The quantity of liquid initially admixed with the silicon particulates is not particularly critical so long as the quantity of liquid added is sufficient to fully wet the silicon particulates and to attract and extract oxidants from the surfaces of silicon particulates. One suitable example ratio of silicon metal particulates to extracting liquid is approximately 1:1 by weight; another suitable example ratio of silicon metal particulates to extracting liquid is approximately 1:1 by volume. The admixing function need only be carried out for a time sufficient to ensure good distribution of the silicon particulates in the liquid. Stirring of the mixture is employed as needed.

In many embodiments, the specific dopant 30 mixed with the silicon metal particulates determines whether the final product is better suited to act as an n-type element or p-type element in a thermoelectric device.

The silicon metal particulates 10, the extracting liquid 20, and the dopant 30 are combined into a mixture and milled 40. In some embodiments, the silicon metal particulates are pre-doped before being added to the mixture. The mixture is introduced into an attrition mill wherein the size of each of the first quantity of silicon metal particulates being greater than about 100 microns is reduced toward a preselected relatively smaller average particle size, producing a second quantity having an average particle size of approximately 12 microns or smaller. In several embodiments, the transfer of the mixture of silicon metal particulates and liquid from vessel to the attrition mill is direct and in the absence of oxidants from an external source. The retention time of the mixture within the attrition mill is dependent upon several factors, such as the initial average particle size of the silicon metal particulates, the speed of operation of the attrition mill, and the preselected final average particle size of the silicon metal particulates. The addition of ceramic pellets (zirconia pellets, for example) to the attrition mill has been found useful in accelerating the milling of the silicon metal particulates.

After milling, at least a portion of the milled mixture is withdrawn 50 and sent on to further processing, where the doped and milled silicon metal particulates are separated 54 from the extracting liquid and unreacted dopant in the mixture. In several embodiments, the separation 54 of the extracting liquid from milled silicon metal particulates takes place in the presence of an inert gas, minimizing the chance of the milled silicon metal particulates being oxidized or otherwise reacting with constituents in the air.

The separated extracting liquid and unreacted dopant are withdrawn 56; the extracting liquid carries with it most or substantially all of the oxidants that contaminated the unmilled silicon metal particulates and would otherwise contaminate the final silicon-based thermoelectric material. In some embodiments, the oxidants are separated 26 from the extracting liquid, and the now-substantially-oxidant-free extracting liquid separated from the mixture is then recycled 28 to be mixed with unmilled initial feedstock silicon metal particulates at an earlier point in the production process.

The substantially oxidant-free and doped silicon metal particulates are recovered 58 and sintered 80 to form the desired the polycrystalline silicon-based thermoelectric material. In many embodiments, the sintering process takes place under an inert atmosphere.

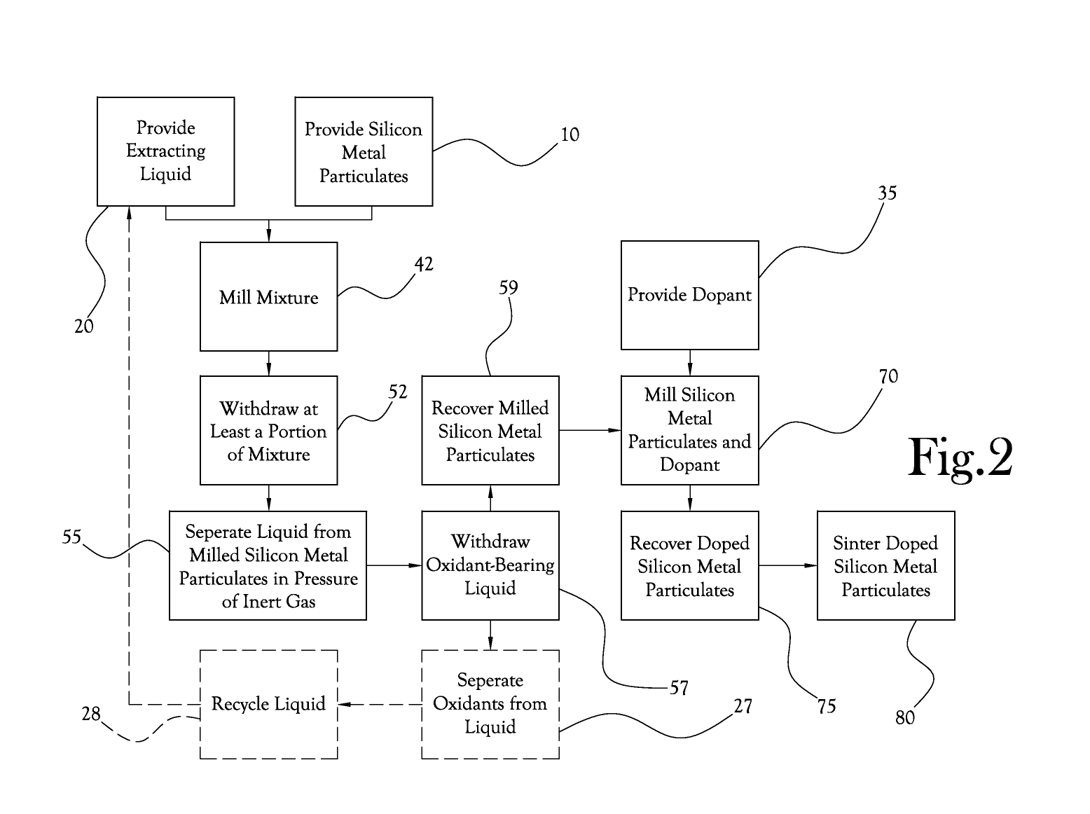

FIG. 2 is a flow diagram illustrating another example embodiment of the present invention, comprising a process for fabricating a sintered polycrystalline silicon-based thermoelectric material. As illustrated in FIG. 2, the process involves providing an initial feedstock of silicon metal particulates 10 and providing an extracting liquid 20 to extract oxidants from the silicon metal particulates. The silicon metal particulates and the extracting liquid are combined into a mixture and milled 42. After milling, at least a portion of the milled mixture is withdrawn 52 and sent on to further processing, where the milled silicon metal particulates are separated 55 from the extracting liquid. In several embodiments, the separation 55 of the extracting liquid from milled silicon metal particulates takes place in the presence of an inert gas, minimizing the chance of the milled silicon metal particulates being oxidized or otherwise reacting with constituents in the air. The separated extracting liquid is withdrawn 57, carrying with it most or substantially all of the oxidants that contaminated the unmilled silicon metal particulates and would otherwise contaminate the final silicon-based thermoelectric material. In some embodiments, the extracting liquid separated from the mixture is then recycled 28 to be mixed with unmilled initial feedstock silicon metal particulates. The substantially oxidant-free silicon metal particulates are recovered 59 and mixed with a dopant 35 to affect the semiconductive properties of the final thermoelectric material; in particular, in many embodiments, the specific dopant 35 mixed with the silicon metal particulates determines whether the final product is better suited to act as an n-type element or p-type element in a thermoelectric device. The mixed silicon metal particulates and dopant are then milled together 70 in a second mill, and doped silicon metal particulates are recovered 75 and sintered 80 to form the desired the polycrystalline silicon-based thermoelectric material. In many embodiments, the sintering process takes place under an inert atmosphere.

In various embodiments, a number of dopants are used to give the final thermoelectric material desired thermal, electrical, and mechanical properties. In some embodiments, dopants include one or more of the following: selenium, tellurium, germanium, tungsten, boron, phosphorus, and arsenic. In some embodiments, the formation of a planar or complexly shaped thermoelectric device includes a process in which one side is fabricated with silicon doped to be an n-type semiconductor and the second side is fabricated with silicon doped to be a p-type semiconductor. In some embodiments, a planar or complexly shaped thermoelectric device includes a first, thick side that is fabricated with silicon doped to be an n-type semiconductor and the second, thin side that is fabricated with silicon doped to be a p-type semiconductor. In some embodiments, a planar or complexly shaped thermoelectric device includes a first, thick side that is fabricated with silicon doped to be an p-type semiconductor and the second, thin side that is fabricated with silicon doped to be a n-type semiconductor. In some embodiments, the thin side of a thermoelectric device comprises a thin film.

In several embodiments, one of the final phases of the fabrication process involves sintering the material into a polycrystalline form and shape with controlled porosity and density. The sintering process comprises a solid-state diffusional process in which adjacent grains and particulates bond at a homologous temperature of approximately 1375°C. In several embodiments, a number of methods are used to shape a mixture of milled and doped silicon metal particulates into a green body for sintering. In various embodiments, the mixture is extruded, injection molded, die-pressed, isostatically pressed or slip cast to produce a green body of desired shape. Sintering of the green body is carried out in an atmosphere that is substantially inert, for example, argon, helium, or a vacuum. In various embodiments, the sintering atmosphere ranges from a substantial vacuum to atmospheric pressure. Sintering is carried out at a temperature ranging from 1000° C. to approximately 1414° C. Generally, sintering temperature is at least 1150° C., and in many embodiments at least 1250° C., to increase the rate of solid state sintering. The particular sintering temperature is determinable empirically and depends largely on particle size, amount of dopant, density of the green body, and final density desired in the sintered thermoelectric material, with higher final densities requiring higher sintering temperatures. Generally, the smaller the size of the milled silicon metal particulates in the green body, and the higher its density, the lower is the required sintering temperature. In most embodiments, sintering is carried out at a temperature below the melting point of silicon, in order to preserve the reticulated porosity of the polycrystalline structure.

In a thermoelectric material fabricated according to a method such as one of the disclosed example embodiments, the porosity of the fabricated structure is reticulated. When the milled and doped silicon metal particulates are sintered, for example as described above, the final polycrystalline product generally exhibits a porosity of at least 20%, and often between 20% and 45%. In some embodiments, the final polycrystalline product generally exhibits a porosity of between 25% and 45%. In some embodiments, the final polycrystalline product generally exhibits a porosity of approximately 35%. The porosity of the sintered polycrystalline thermoelectric material contributes to the low density of the material, and the low density of the material gives the material a lower thermal conductivity than many competing semiconductive products. In some embodiments, the final polycrystalline product exhibits a thermal conductivity in the range of 8 to 12 Watts per meter Kelvin. Further, it is possible to infiltrate the porous thermoelectric structure with a variety of materials to modify the thermal conductivity, electrical conductivity, and Seebeck coefficient of the fabricated thermoelectric structure. For example, in some embodiments, reticulated porous spaces in the polycrystalline thermoelectric material are infiltrated with ethyl silicate or colloidal silica (two example substances with low thermal conductivity and low coefficients of thermal expansion).

In several example embodiments, the final product is a silicon-based thermoelectric material comprising a heterogeneous mixture of silicon metal particulates, substantially free of oxidants, with a dopant added to affect the semiconductive properties of the thermoelectric material, the heterogeneous mixture having been sintered to form a polycrystalline silicon-based thermoelectric material. In some example embodiments, the thermoelectric material includes at least two layers having different thermoelectric properties.

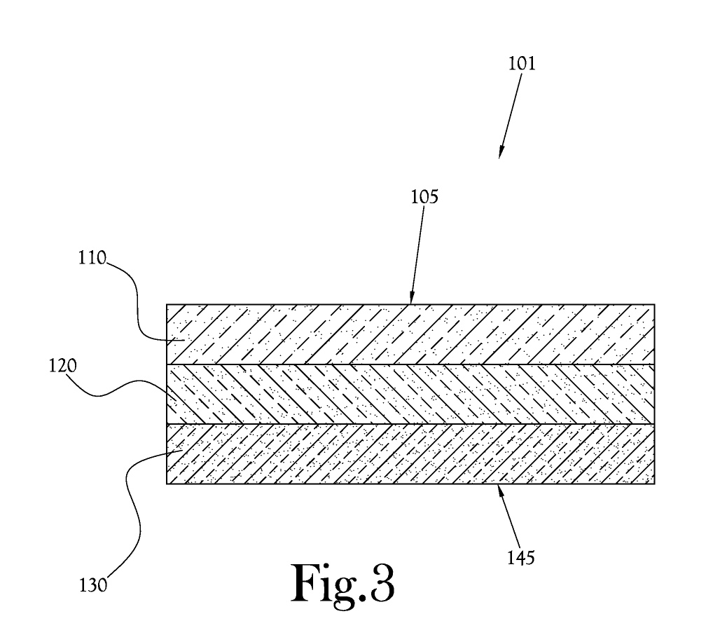

In some example embodiments, a thermoelectric device comprises multiple layers of polycrystalline silicon-based thermoelectric materials, with each layer having at least a slightly different material composition and therefore having a different thermal conductivity, electrical conductivity, or Seebeck coefficient from an adjacent layer. FIG. 3 illustrates one example embodiment of a multi-layer thermoelectric device. As shown in FIG. 3, a thermoelectric device 101 comprises three layers, including a top layer 110, a middle layer 120, and a bottom layer 130; the three layers combine to form a laminate body with an upper face 105 and a lower face 145. In the illustrated example embodiment, each of the three layers contains a different combination of milled silicon metal particulates and dopant. In the illustrated example embodiment, all layers contain the same dopant, but the layers differ in that the top layer 110 contains the lowest concentration of dopant (or, alternatively, the lowest amount of dopant as a weight percentage of the total heterogeneous mixture in the top layer 110); the middle layer 120 conatins a slightly higher concentration of dopant than the top layer 110; and the bottom layer contains the highest concentration of dopant of all the three layers. As a result of the differing concentrations of dopant, each layer has slightly different semiconductive and thermoelectric properties. In the illustrated example embodiment, the top layer 110 has less thermal and electrical conductivity than the layers below it. Therefore, in one use of the illustrated example embodiment multilayer thermoelectric device, the upper face 105 of the device 101 faces a heat source, and the lower face 145 of the device 101 faces the cold side of the thermal gradient; having the top layer 110, with its relatively low thermal conductivity, facing the heat source protects the structural integrity of the device 101 and helps to maintain the temperature gradient across the cross-section of the device 101. At the same time, the other layers 120 and 130, with their greater electrical conductivity, are well equipped to take advantage of the electron flow through the top layer 110. Those of skill in the art will recognize that other uses for multi-layer thermoelectric devices are possible and are contemplated by the present invention.

In some alternative example embodiments that comprise thermoelectric device with multiple layers of polycrystalline silicon-based thermoelectric materials, the layers differ in that each layer comprises a different dopant or a different combination or ratio of dopants. For example, in an example embodiment, a three-layer thermoelectric device includes one layer in which the principal dopant includes selenium; one layer in which the principal dopant includes tellurium; and one layer in which the principal dopant includes tungsten. As a result of the dopant differences, each layer has different semiconductive and thermoelectric properties.

In some alternative example embodiments that comprise thermoelectric device with multiple layers of polycrystalline silicon-based thermoelectric materials, the layers differ in that the density of each layer is different from the density of other layers in the device. As a result of the density differences, each layer has different semiconductive and thermoelectric properties.

In some of the several embodiments, the present invention allows for the fabrication of planar, net-shaped, or complexly shaped thermoelectric devices that are capable of being installed in a variety of places, and in particular are capable of being installed in places to absorb waste heat from machinery or equipment and transform the waste heat into electricity. For example, thermoelectric devices according to some of the example embodiments of the present invention are capable of being wrapped around pipes in some industrial settings, absorbing heat from the pipe.

The methods and processes disclosed above are useful for producing highly efficient silicon-based thermoelectric materials that have high Seebeck coefficients, high electrical conductivity, and low thermal conductivity, with the precise parameters of each silicon-based thermoelectric material dependent upon the nature of the dopant, the particle size of the milled silicon metal particulates, and the density of the final sintered polycrystalline thermoelectric material. Such thermoelectric materials are susceptible to being worked to construct planar and complex net-shaped objects that can be fitted into locations where they may be used to recover waste heat. Such thermoelectric materials have cross sections with properties to maintain an adequate temperature differential between the two opposing sides in order to generate voltage efficiently. These silicon-based thermoelectric materials generally have larger cross sections than many competing thermoelectric and semiconductor materials. The larger cross section of such silicon-based thermoelectric materials is useful for maintaining a temperature gradient. Doped silicon-based thermoelectric material have high tensile strength, have resistance to thermal shock, and are formable into layers to allow the creation of graded indices for electrical, thermal, or other parameters. These silicon-based thermoelectric materials are useful in a number of contexts, and it is feasible to use them to efficiently recover heat over a large range of temperatures. In some embodiments, silicon-based thermoelectric materials are able to efficiently recover heat within a range of 50° C. to 1100° C.

Thermoelectric materials fabricated according to some of the several embodiments of the present general inventive concept maintain good Seebeck coefficient while getting high values for electrical conductivity. In some embodiments, employing larger atoms for doping, such as arsenic, particularly on the N leg, allows less mobility within the material and enhances the usefulness of the material in high temperature operations. Additionally, in some embodiments, larger legs can take advantage of space, time and velocity to realize more efficient operation and higher unaided Delta T.

In some embodiments, silicon-based thermoelectric materials fabricated according to some of the several embodiments of the present general inventive concept provide increased Seebeck coefficient, high electrical conductivity and low thermal conductivity. Silicon has the advantage of a low CTE (less than 4 ppm) and low cost. Silicon pellets can be made economically in large cross sections, supporting large unaided Delta T. Industrial milling facilitates the fabrication of porous structures instead of bulk hot pressed structures, thus providing a finished product with a lower thermal conductivity.

Further, in several example embodiments, the use of nano-structuring allows parctitioners to obtain very low thermal conductivity in the finished product. The construction of a porous nano-structure of oxygen-free doped silicon also provides for a material with low thermal conductivity. Doping the material with boron adds low electrical resistivity. The result is a thermoelectric material with a high Seebeck coefficient, optimized electrical conductivity, and low thermal conductivity. In some embodiments, it is possible to engineer a material with thermal conductivity of less than 1 W/MK using nanostructures. It is further possible to dope for low electrical resistivity, using boron for example. In some embodiments, the material is “overdoped” with boron to achieve desired properties. In some embodiments, the doping also includes such materials as phosphorous or arsenic.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A process for fabricating a silicon-based thermoelectric material comprising:
providing an initial feedstock of silicon metal particulates;
providing an extracting liquid to extract oxidants from the silicon metal particulates;
combining the silicon metal particulates and the extracting liquid into a mixture and milling said mixture;
withdrawing at least a portion of the milled mixture;
within the withdrawn portion of the milled mixture, separating milled silicon metal particulates from the extracting liquid
mixing the silicon metal particulates with a dopant to affect the semiconductive properties of the thermoelectric material;
milling the silicon metal particulates and dopant;
recovering doped silicon metal particulates; and
sintering recovered doped silicon metal particulates to form a silicon-based thermoelectric material.

2. The process of claim 1 wherein said dopant includes an element selected from the group consisting of selenium, tellurium, germanium, tungsten, boron, phosphorus, and arsenic.

3. The process of claim 1 wherein said dopant includes selenium.

4. The process of claim 1 wherein said dopant includes boron.

5. The process of claim 1 wherein said dopant includes arsenic.

6. The process of claim 1 wherein said sintering is carried out at a temperature of between 1000 degrees Celsius and 1414 degrees Celsius.

7. The process of claim 1 wherein said sintering is carried out in an inert atmosphere.

8. A method for fabricating a silicon-based thermoelectric material comprising:
admixing a first quantity of silicon metal particulates with a liquid having the ability to extract one or more oxidants from the silicon metal particulates, said step of admixing maintained for a time sufficient for wetting the first quantity of silicon metal particulates in the liquid prior to attrition to develop a mixture of liquid and oxidant-free particulates,
introducing said mixture of particulates and liquid into an attrition mill in the absence of oxidants,
subjecting said silicon metal particulates of said mixture to attrition in the attrition mill for a time sufficient to reduce at least a portion of said silicon metal particulates to a preselected average particle size and for said liquid to extract one or more oxidants from said silicon metal particulates to produce a second quantity of reduced particle size silicon metal particulates being essentially oxidant free,
withdrawing from said attrition mill at least a portion of said second quantity of reduced particle size silicon metal particulates, along with a portion of said liquid,
admixing the withdrawn reduced particle size silicon metal particulates with a dopant to affect the semiconductive properties of the thermoelectric material,
milling the silicon metal particulates and dopant;
recovering doped silicon metal particulates; and
sintering recovered doped silicon metal particulates to form a silicon-based thermoelectric material.

9. The method of claim 8 wherein said dopant includes an element selected from the group consisting of selenium, tellurium, germanium, tungsten, boron, and phosphorus.

10. The method of claim 8 wherein said sintering is carried out at a temperature of between 1000 degrees Celsius and 1414 degrees Celsius.

11. The method of claim 8 wherein said sintering is carried out at a temperature of at least 1150 degrees Celsius.

12. The method of claim 8 wherein said sintering is carried out at a temperature of at least 1250 degrees Celsius.

13. The method of claim 8 wherein said sintering is carried out in an inert atmosphere.

14. A silicon-based thermoelectric material comprising:
a heterogeneous mixture of silicon metal particulates with a dopant, said dopant to affect the semiconductive properties of the thermoelectric material, said silicon metal particulates being substantially free of oxidants,
said heterogeneous mixture of silicon metal particulates with a dopant having been sintered to form a polycrystalline silicon-based thermoelectric material.

15. The silicon-based thermoelectric material of claim 14 wherein said dopant includes an element selected from the group consisting of selenium, tellurium, germanium, tungsten, boron, and phosphorus.

16. The silicon-based thermoelectric material of claim 14 wherein the thermoelectric material includes at least two layers having different thermoelectric properties.

17. The silicon-based thermoelectric material of claim 14 wherein the thermoelectric material exhibits a porosity of at least 20%.

18. The silicon-based thermoelectric material of claim 14 wherein the thermoelectric material exhibits a porosity of between 20% and 45%.

19. The silicon-based thermoelectric material of claim 14 wherein the thermoelectric material exhibits a porosity of between 25% and 45%.

20. The silicon-based thermoelectric material of claim 14 wherein the thermoelectric material exhibits a porosity of approximately 35%.
